(19) United States
(12) Patent Application Publication
(10) Pub. No.: US 2004/0023720 A1
(43) Pub. Date: Feb. 5, 2004

(54) Controller

(76) Inventor: Yoshitaka Sakoh, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/620,703

(22) Filed: Jul. 17, 2003

(30) Foreign Application Priority Data
Jul. 30, 2002 (JP) P2002-222188

(51) Int. Cl. A63F 13/02

(52) U.S. Cl. 463/37

(57) ABSTRACT

A controller includes a battery terminal holding member, a switch board holding member holding a switch board on which a push switch is mounted, a parts holding member, mounted on a main board. The battery terminal and the switch board are integrally formed on the parts holding member.

### BACKGROUND OF THE INVENTION

The present invention relates to a controller and, more particularly, a battery built-in type controller.

Normally the game controller is connected to the computer game machine via the cable. However, in a wireless type game controller, the battery is required to be built in the game controller as the power supply of the signal transmitter/receiver circuit. As the battery installing and connecting method in this case, normally the battery contact board is fitted onto the main board in the controller and then the battery contact board and the main board are connected by the soldering. Because of the bending stress applied to the main board via the battery contact board at the time of attaching/detaching the battery, there is such a possibility that the soldered portions of the battery contact board are cracked or the printed-circuit patterns of the main board are disconnected. Also, since the battery contact boards are exposed, there is such a possibility that they are brought into contact mutually to cause the short-circuit.

Also, normally a pair of multi-directional keys, which are operated by left and right thumbs of a user, and a pair of push keys, which are operated by left and right forefingers of the user, are provided to the controller. The push switch board that receives the operation of the back-and-forth moved push keys is fitted perpendicularly to the horizontal main board. However, a means for holding the switch board more firmly is desired.

### SUMMARY OF THE INVENTION

It is therefore an object of the present invention to provide a controller, being enable to eliminate a possibility of damages of a battery contact board portion and a main board and a push switch board portion.

In order to achieve the above object, according to the present invention, there is provided a controller comprising:

a battery terminal holding member;

a switch board holding member, holding a switch board on which a push switch is mounted;

a parts holding member, mounted on a main board,

wherein the battery terminal holding member and the switch board are integrally formed on the parts holding member.

Preferably, the battery terminal holding member holds a battery terminal board, and a rib is formed on the battery terminal holding member such that the battery terminal board is positioned to the battery terminal holding member.

Preferably, the rib is formed so as to surround the battery terminal board.

A reinforcement rib is formed on the switch board holding member so as to receive a pushing force generated by an operation of the push switch.

In the above configurations, since the battery terminal holding member and the switch board holding member are held by the parts holding member that is provided separately from the main board, the stress applied to the main board can be reduced and the reliability and the durability can be improved. Also, since the battery terminal holding member and the switch board holding member are integrally formed as one parts, the number of parts and the man-hour can be reduced.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a bottom perspective view of a game controller showing an embodiment of the present invention;

FIGS. 2A through 2C are views showing a parts holder, wherein FIG. 2A is a plan view, FIG. 2B is a front view, and FIG. 2C is a right side view; and

FIGS. 3A and 3B are views showing the parts holder, wherein FIG. 3A is a rear view and FIG. 3B is a bottom view.

### DETAILED DESCRIPTION OF THE PREFERRED EMBODIMENTS

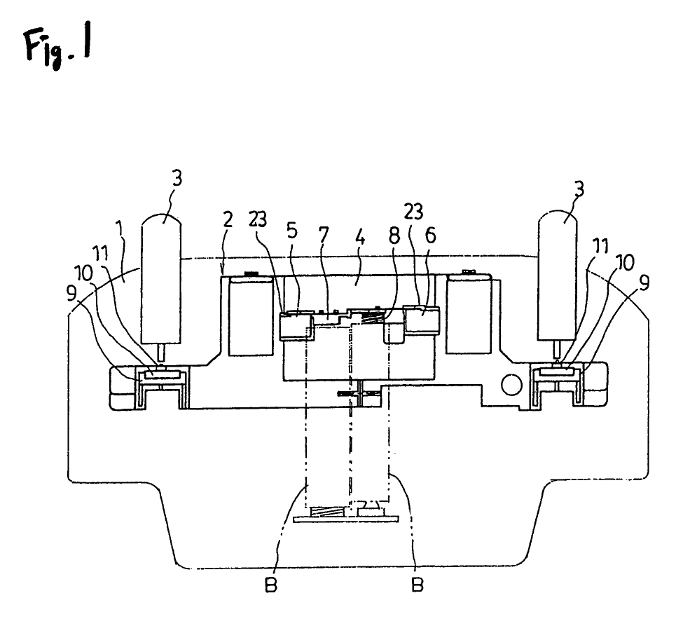

An embodiment of the present invention will be explained in detail in accordance with the drawings hereinafter. FIG. 1 is a view showing a main board 1 of a game controller as viewed from a bottom surface, and a reference number 2 shows a parts holder as the essential portion of the present invention. A push key 3 is provided to protrude from the inside of a housing (not shown) to the front side (upper side in FIG. 1). The parts holder 2 is mounted on the main board 1. (+) electrodes and (−) electrodes of two batteries B contact to (+) contacts 7 and (−) contacts 8 of two battery terminal boards 5, 6 that are provided on a center table portion 4. Also, push switch boards 10 provided separately from the main board 1 are provided perpendicularly to board holder portions 9 formed like two wings that extend leftward and rightward. Push switches 11 provided on the push switch boards 10 are opposed to the back surfaces of the push keys 3. When the push key 3 is pulled to this side, the push switch 11 is pushed by the push key 3 to turn ON.

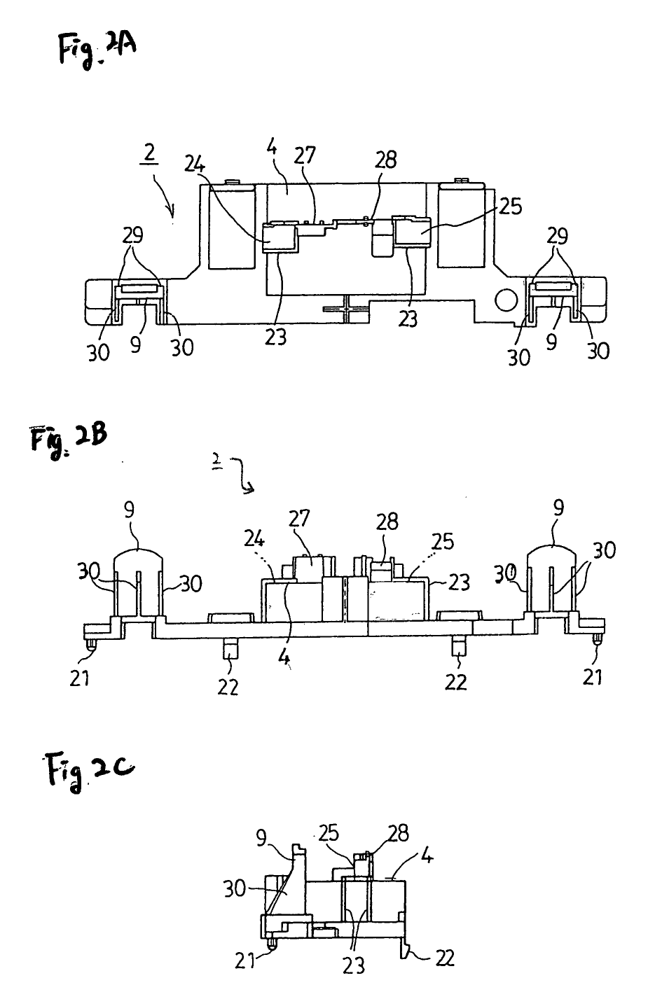

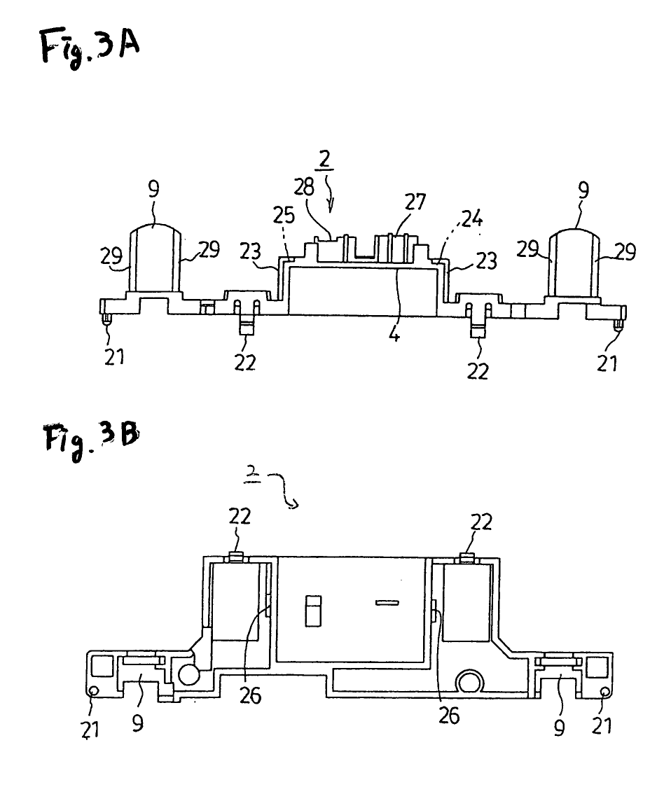

FIGS. 2A through 2C and FIGS. 3A and 3B show a parts holder 2. The parts holder 2 is positioned by inserting positioning pins 21 into pin holes in the main board 1. The pin holes are provided to both left and right ends of the bottom surface of the parts holder 2. The parts holder 2 is fixed to the main board 1 by engaging hooks 22, which are provided to a rear edge of the bottom surface, with square holes formed in the main board 1. Battery terminal holder portions 24, 25, which are surrounded by a rib 23 respectively, are formed on both left and right sides of a square table portion 4. The square table portion 4 is provided at the center of the parts holder 2. The rib 23 is formed continuously from the top surface of the table portion 4 to a lower end of a side surface thereof. When the battery terminal board (not shown), which is formed by bending a metal plate, is set to the battery terminal holder portions 24, 25, lower end portions of the battery terminal board are projected downward via holes 26 in the bottom plate shown in FIG. 3B, and then are connected to the power-supply circuit patterns of the main board 1 by the soldering. A (+) contact holder portion 27 and a (−) contact holder portion 28 are provided to the insides of a pair of left and right battery terminal holder portions 24, 25 to stand vertically from the top surface of the table portion 4. A (+) contact and a (−) contact on the upper portion of the battery terminal board, which are bent at a right angle, are latched onto the (+) contact holder portion 27 and the (−) contact holder portion 28 respectively to constitute battery contacts.

Next, the board holder portion 9 will be explained. The board holder portions 9 arranged on both ends of the parts holder 2 is risen vertically. Ribs 29 are formed on both left and right ends of the back surface of the board holder portion 9 in the vertical direction to hold the switch board that is inserted between the back-surface ribs 29. As shown in FIG. 2B, reinforcing ribs 30 are provided on the front surface of the board holder portion 9 to withstand the pressure applied by the push keys from the back-surface direction.

In this manner, the battery terminal board is held by the parts holder 2, and the back-and-forth movement of the battery terminal board is suppressed by the ribs 23 that surround the periphery of the battery terminal board. Therefore, since the parts holder 2 receives the external force applied to the battery terminal board at the time of the battery exchange, etc., the bending stress, the torsional stress, etc. applied to the main board 1 can be reduced. Also, since the battery terminal board is surrounded by the ribs 23, such a possibility can be reduced that the conductive substance contacts to the surface of the battery terminal board to cause the short-circuit. In addition, since the switch board is also held vertically by the parts holder, the endurance can be improved.

In this case, the present invention is not limited to above embodiment, and various variations and modifications can be applied within the technical scope of the present invention. It is a matter of course that the present invention should cover these variations and modifications.

What is claimed is:

1. A controller, comprising:
a battery terminal holding member;
a switch board holding member, holding a switch board on which a push switch is mounted; and
a parts holding member, mounted on a main board,
wherein the battery terminal holding member and the switch board holding member are integrally formed on the parts holding member.

2. The controller as set forth in claim 1, wherein the battery terminal holding member holds a battery terminal board;
wherein a rib is formed on the battery terminal holding member such that the battery terminal board is positioned to the battery terminal holding member.

3. The controller as set forth in claim 2, wherein the rib is formed so as to surround the battery terminal board.

4. The controller as set forth in claim 1, wherein a reinforcement rib is formed on the switch board holding member so as to receive a force generated by an operation of the push switch.
